(19) United States
(12) Patent Application Publication
(10) Pub. No.: US 2014/0260787 A1
(43) Pub. Date: Sep. 18, 2014

(54) SELECTIVELY STRENGTHENED CRANKSHAFT

(71) Applicant: ELECTRO-MOTIVE DIESEL, INC., LaGrange, IL (US)

(72) Inventors: Vijaya Kumar, Darien, IL (US); Jin Yu, Westmont, IL (US)

(73) Assignee: Electro-Motive Diesel, Inc., LaGrange, IL (US)

(21) Appl. No.: 13/846,379

(22) Filed: Mar. 18, 2013

(51) Int. Cl. C21D 1/06; F16C 3/14

(52) U.S. Cl. CPC C21D 1/06; F16C 3/14
USPC 74/605; 29/888.08

(57) ABSTRACT

A crankshaft having a crankpin journal, a main journal joined to the crankpin journal by a crank web, is provided. The crankpin journal and the main journal have a hardened surface upto a first pre-determined depth. The crankshaft further includes a crankpin journal fillet joining the crankpin journal and the crank web. The crankpin journal fillet includes a hardened surface strengthened by a peening process. The crankshaft further includes a main journal fillet joining the main journal and the crank web. The main journal fillet includes a hardened surface strengthened by the peening process. The crankshaft also includes an oil passage extending through the crankpin journal and the main journal. The oil passage extends such that a portion of a surface proximate to the oil passage is hardened to a second pre-determined depth.

### TECHNICAL FIELD

The present disclosure relates to a crankshaft, and more particularly to a selectively strengthened crankshaft.

### BACKGROUND

Typically, a crankshaft includes main and crankpin journals in tandem relationship with adjacent journals being radially offset from each other and integrally joined by crank webs. The surfaces of these journals blend into the surfaces of the crank webs through transitional surfaces referred to as fillets.

The journal surfaces are subjected to severe wear and tear conditions. Therefore, it has been conventionally known to harden the surfaces of the journals. The crankshaft during operation is also subjected to very high bending and twisting forces which produce large stresses throughout the crankshaft, and particularly in the area of the fillets. Therefore, in order to increase the strength of the crankshaft, it is also conventionally known to extend the hardening of the journal surfaces into and around the fillets.

However, the surface hardening of the fillet has also resulted in decreased ductility of these fillets. Therefore, the fillet in high stress condition would result in cracking of the material instead of flowing to relieve the stresses. The cracks in the material would further serve as stress concentration points in the crankshaft when the crankshaft is subjected to working forces.

U.S. Pat. No. 8,222,577 relates to a method of treating a crank pin of a crankshaft. In the method, hardness of the crank pin surface is measured and when the hardness is over a pre-determined limit value, depth of the hard spot is measured. Heat treatment parameters are determined, at least on the basis of the depth measurement and the hard spot is heat treated. During the heat treatment the hard spot is heated by an induction heating device.

### SUMMARY

In one aspect, the present disclosure provides a crankshaft. The crankshaft includes a crankpin journal and a main journal joined to the crankpin journal by a crank web. The crankpin journal and the main journal have a hardened surface up to a first pre-determined depth. The crankshaft further includes a crankpin journal fillet joining the crankpin journal and the crank web. The crankpin journal fillet includes a hardened surface strengthened by a peening process. The crankshaft further includes a main journal fillet joining the main journal and the crank web. The main journal fillet includes a hardened surface strengthened by the peening process. The crankshaft also includes an oil passage extending through the crankpin journal and the main journal. The oil passage extends such that a portion of the surface, proximate to the oil passage is hardened to a second pre-determined depth.

In another aspect, a method for strengthening a crankshaft is provided. The crankshaft includes a crankpin journal and a main journal joined to the crankpin journal by a crank web. The crankshaft further includes a crankpin journal fillet joining the crankpin journal and the crank web. The crankshaft further includes a main journal fillet joining the main journal and the crank web. The crankshaft also includes an oil passage extending through the crankpin journal and the main journal. The method includes hardening the crankpin and main journal fillet. Further, the method includes strengthening the crankpin journal fillet and the main journal fillet by a peening process. Furthermore, the method includes hardening a surface of each of the crankpin journal and the main journal up to a first pre-determined depth and hardening a portion of the surface proximate to the oil passage up to a second pre-determined depth.

In yet another aspect, the present disclosure provides a method for strengthening a crankshaft is provided. The crankshaft includes a crankpin journal and a main journal joined to the crankpin journal by a crank web. The crankshaft further includes a crankpin journal fillet joining the crankpin journal and the crank web. The crankshaft further includes a main journal fillet joining the main journal and the crank web. The crankshaft also includes an oil passage extending through the crankpin journal and the main journal. The method includes hardening the crankpin and main journal fillet. The method further includes strengthening the crankpin journal fillet and the main journal fillet by a peening process.

In another aspect, the present disclosure provides a method for strengthening a crankshaft is provided. The crankshaft includes a crankpin journal and a main journal joined to the crankpin journal by a crank web. The crankshaft further includes a crankpin journal fillet joining the crankpin journal and the crank web. The crankshaft further includes a main journal fillet joining the main journal and the crank web. The crankshaft also includes an oil passage extending through the crankpin journal and the main journal. The method includes hardening a surface of each of the crankpin journal and the main journal upto a first pre-determined depth and hardening a portion of the surface proximate to the oil passage upto a second pre-determined depth on the crank pin journal.

Other features and aspects of this disclosure will be apparent from the following description and the accompanying drawings.

### BRIEF DESCRIPTION OF THE DRAWINGS

FIG. 1 is a perspective view of a crankshaft;

FIG. 2 is a portion of the crankshaft of FIG. 1;

FIGS. 3 and 4 are sectional views of the crankshaft taken in direction of arrows in FIG. 2; and

FIG. 5 illustrates a method of hardening the crankshaft of FIG. 1, according to an aspect of the present disclosure.

### DETAILED DESCRIPTION

FIG. 1 illustrates a perspective view of a crankshaft 100 disposed rotatably within a cylinder block of an internal combustion engine (not shown). As illustrated in FIG. 1, the crankshaft 100 may include a front end 102, a rear end 104 and a central axis of rotation A-A′. The rear end 104 may include a flange 106 configured to be attached to a flywheel.

Further, the crankshaft 100 may be configured to be rotatably mounted within the cylinder block of the engine, by a number of main journals 108, 110, 112, 114, 116, 118 and 119 aligned longitudinally with the central axis A-A′. The crankshaft 100 further includes a number of crank webs 120, 122, 123, 124, 125, 126, 127, 128, 130, 132, 133, 134 and crankpin journals 136, 137, 138, 139, 140 and 142 for journaling respective connecting rods (not shown). The crankpin journals 136-142 are installed between pairs of adjacent crank webs, such as 120-122, 123-124, 125-126, 127-128, 130-132 and 133-134 respectively. The crank webs 120-134 couple the crankpin journals 136-142 to the main journals 108-119.

Generally, pistons may be connected to the crankshaft 100 by connecting rods, such that one end of the connecting rod may be pivotally connected to the corresponding piston. A second end of the connecting rods may be pivotally connected to the corresponding crankpin journals 136-142 using bearings. The reciprocating motion of the pistons is converted into rotary motion of the crankshaft 100 via the connecting rods. In multi-cylinder engines, the crankshaft 100 may arrange crankpin journals 136-142, such that one crankpin journal connects to each connecting rod (in case of an inline engine) or one crankpin journal connects to two connecting rods (in case of a V-type engine). The arrangement of the crankpin journals 136-142 is such that, power from each cylinder is applied to the crankshaft 100 at an appropriate point during the rotation.

Furthermore, the crankshaft 100 may include a number of counterweights, such as counterweights 144, 145, 146, 147, 148, 149, 150 and 151 secured to the respective crank webs. The counterweights 144-151 may be configured to counteract unbalanced forces arising during the operation of the engine.

The crankshaft 100 may further include a number of oil passages, such as oil passages 152 (only one is shown) extending through the main journal 108 and crankpin journal 136 and terminating at openings 153 on the crankpin journals 136-142 and the main journals 108-119. The oil passage 152 configured to allow a lubricant flow to lubricate to the crankpin journal 136 and the main journal 108. It is to be understood, that although only one oil passage 152 is shown in the figure, there may be more number of oil passages extending through the main journals 108-119 to the adjacent crankpin journals 136-142.

FIG. 2 illustrates a portion of the crankshaft 100 of FIG. 1, in accordance with an embodiment of the present disclosure. FIG. 3 illustrates a sectional view of the crankshaft 100 in the direction I-I of FIG. 2. Referring to FIGS. 2 and 3, the crankshaft 100 includes a number of crankpin journal fillets, such as crankpin journal fillet 202 and a number of main journal fillet, such as main journal fillet 204. The crankpin journal fillet 202 may be defined as a transitional rounded region between the crankpin journal, such as the crankpin journal 136 and a crank web, such as the crank webs 120 and 122. Further, the main journal fillet 204 may be defined as a transitional rounded region between the main journals, such as the main journal 108 and the crank webs, such as the crank web 120.

In an aspect of the present disclosure, the crankpin journal fillet 202 and the main journal fillet 204 may include a hardened surface that is hardened using induction hardening process. The induction hardening process may be understood as a process of electrically heating the surface of the crankpin journal fillet 202 and the main journal fillet 204 and introducing these surfaces to rapid cooling by the process of quenching. Although, the hardening process is described to be induction-hardening process, however, it will be understood that any other surface hardening process may be used to harden the crankpin journal fillet 202 and the main journal fillet 204. Examples of other hardening processes may include, but not limited to, nitriding, cyaniding, carburizing and the likes.

In one embodiment, the crankpin journal fillet 202 and the main journal fillet 204 may further include strengthened fractional arcuate portions to introduce residual compressive stresses at these portions to increase the fatigue limit of the crankpin journal fillet 202 and the main journal fillet 204. These fractional arcuate portions correspond to fatigue zones in which there is a potential for significant fatigue. For example, fractional, arcuate portions 206 and 208 of the circumference of the crankpin journal fillet 202 and the main journal fillet 204 respectively may be strengthened using a peening process. Peening is a process of introducing mechanical stress into the surface layer of a metal surface or part to compress and strengthen it against future fractures and wear. In one embodiment, stroke peening is used to strengthen the fractional arcuate portions 206 and 208. Generally, stroke peening is applied to the already hardened crankpin journal fillet 202 and the main journal fillet 204 by using hammer blows. In various alternate embodiments, any other type of peening process such as shot peening may be used for strengthening.

In an aspect of the present disclosure, the fractional arcuate portion 206 of the crankpin journal fillet 202 may extend over an arc of a first angle X centered on an axis 302 of overlap portion of the main journals, such as main journal 108 and the crankpin journals, such as the crankpin journal 136 (see FIG. 3). For example, the first angle X may be about 145 degrees, and the fractional arcuate portion 206 of the crankpin journal fillet 202 may extend over an arc of about 145 degrees centered on the axis 302.

In a further aspect of the present disclosure, the fractional arcuate portion 208 of the main journal fillet 204 may extend over an arc of a second angle Y centered on the axis 302. In one embodiment, the second angle Y may be about 120 degrees, and the fractional arcuate portion 208 of the main journal fillet 204 may extend over an arc of about 120 degrees centered on the axis 302.

FIG. 4 illustrates a section of the crankshaft 100 taken in direction II-II of FIG. 2. As illustrated in the figure, a surface 402 of the crankshaft 100 in proximity to the crankpin journals 136-142 may be hardened using induction hardening process upto a first pre-determined depth D1. In one embodiment, D1 may substantially be within a range of about 4.0 mm to 5.5 mm. Although the figure shows that the surface 402 in proximity to the crankpin journals 136-142 is hardened to the first pre-determined depth, however it will be understood that the hardening of the surface 402 may be extended to the surface 402 in proximity to the main journals 108-119.

In a further embodiment, a portion of the surface 402 in proximity to the oil passages, such as the oil passage 152 may be hardened upto a second pre-determined depth D2. In an example, the portion of the surface 402 in proximity to the openings 153 of the oil passages 152 is hardened upto the second pre-determined depth D2. In one embodiment, the second pre-determined depth D2 is greater than the first pre-determined depth D1. For example, the second pre-determined depth D2 may substantially be within a range of about 6.0 mm to 7.5 mm.

### INDUSTRIAL APPLICABILITY

Typically, a crankshaft includes main and crankpin journals in tandem relationship with adjacent journals being radially offset from each other and integrally joined by crank webs. The surfaces of these journals blend into the surfaces of the crank webs through transitional surfaces referred to as fillets.

The journal surfaces are subjected to severe wear and tear conditions. Therefore, it has been conventionally known to harden the surfaces of the journals. The crankshaft in operation is also subjected to very high bending and twisting forces which produce large stresses throughout the crankshaft, and particularly in the area of the fillets. Therefore, in order to increase the strength of the crankshaft, it is also conventionally known to extend the hardening of the journal surfaces into and around the fillets.

However, the surface hardening of the fillet has also resulted in decreased ductility of these fillets. Therefore, the fillet in high stress condition would result in cracking of the material instead of flowing to relieve the stresses. The cracks in the material would further serve as stress concentration points in the crankshaft when the crankshaft is subjected to working forces.

To this end, the crankshaft 100 is disclosed herein. The crankshaft 100 includes crankpin fillets 202 and main journal fillet 204 strengthened at fractional arcuate portions 206 and 208 respectively using a peening process such as stroke peening to introduce residual compressive stresses. Further, the depth D2 of the hardness in the area of the surface near the oil passages, such as oil passage 152 is greater than the depth D1 of the hardened surface of the crankpin journal 136-142.

Peening of the surface of the hardened crankpin fillets 202 and main fillet 204 using stroke peening is a less expensive way to increase the load carrying capacity of the crankshaft 100 without increasing the journal diameters. Further, the crankshaft 100 as disclosed in the present disclosure possesses high strength to bear high operation loads due to cylinder operation, peak firing pressure increase etc. Furthermore, the crankshaft 100 maintains optimum size of the main journals 108-119 and the crankpin journals 136-142.

FIG. 5 illustrates an exemplary method 500 for hardening the crankshaft 100. Initially, at step 502, crankpin journal fillet 202 and main journal fillet 204 are hardened. In one embodiment, the crankpin journal fillet 202 and the main journal fillet 204 are hardened using induction hardening process.

Further, at step 504, the crankpin journal fillet 202 may be strengthened using a peening process. For example, the crankpin journal fillet 202 is strengthened using stroke peening process. In one embodiment, stroke peening may be applied to fractional, arcuate portions such as the fractional arcuate portion 206 of the circumference of the crankpin journal fillet 202. For example, the fractional arcuate portion 206 of the crankpin journal fillet 202 may extend over an arc of about 145 degrees centered on the axis 302 of overlap portion of the main journals, such as main journal 108 and the crankpin journals, such as the crankpin journal 136.

At step 506, the main journal fillet 204 may be strengthened using the peening process. For example, the main journal fillet 204 is strengthened using stroke peening process. In one embodiment, stroke peening is applied to the first fractional, arcuate portion 208 of the circumference of the main journal fillet 204. For example, the fractional, arcuate portion 208 of the main journal fillet 204 may extend over an arc of 120 degrees centered on the axis 302.

Furthermore, at step 508, a surface 402 of each of the crankpin journal 136-142 is hardened to a first pre-determined depth D1. In one embodiment, the first pre-determined depth D1 is substantially within a range of about 4.0 mm to 5.5 mm. For example, the surface is hardened using stroke peening,

At step 510, a portion of the surface 402 proximate to the oil passage 152 is hardened to a second pre-determined depth D2. In one embodiment, the second pre-determined depth D2 is greater than the first pre-determined depth D1. For example, the second pre-determined depth D2 is substantially within a range of about 6.0 mm to 7.5 mm.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A crankshaft comprising:
at least one crankpin journal having a hardened surface upto a first pre-determined depth;
at least one main journal coupled to the at least one crankpin journal by a crank web, the main journal having a hardened surface upto the first pre-determined depth;
at least one crankpin journal fillet joining the crankpin journal and the crank web, the crankpin journal fillet having a hardened surface strengthened by a peening process;
at least one main journal fillet joining the main journal and the crank web, the main journal fillet having a hardened surface strengthened by the peening process; and
at least one oil passage extending through the crankpin journal and the main journal such that a portion of a surface proximate to the oil passage is hardened upto a second pre-determined depth.

2. The crankshaft of claim 1, wherein the surface of the crankpin journal, the main journal, the crankpin journal fillet and the main journal fillet is hardened by induction hardening.

3. The crankshaft of claim 1, wherein the crankpin journal fillet includes a fractional arcuate portion extending over an arc of 145 degrees on an axis of overlap portion of the main journal and the crankpin journal.

4. The crankshaft of claim 3, wherein the fractional arcuate portion of the crankpin journal fillet is strengthened by the peening process.

5. The crankshaft of claim 1, wherein the main journal fillet includes a fractional arcuate portion extending over an arc of 120 degrees on an axis of overlap portion of the main journal and the crankpin journal.

6. The crankshaft of claim 5, wherein the fractional arcuate portion of the main journal fillet is strengthened by the peening process.

7. The crankshaft of claim 1, wherein the hardened surface of the crankpin journal fillet and the main journal fillet is strengthened by stroke peening.

8. The crankshaft of claim 1, wherein the second pre-determined depth is greater than the first pre-determined depth.

9. A method for strengthening a crankshaft having at least one crankpin journal, at least one main journal joined to the at least one crankpin journal by a crank web, a crankpin journal fillet joining the crankpin journal and the crank web, a main journal fillet joining the main journal and the crank web, and at least one oil passage extending through the crankpin journal and the main journal, the method comprising:
hardening the crankpin journal fillet and the main journal fillet;
strengthening the crankpin journal fillet by a peening process;
strengthening the main journal fillet by the peening process;
hardening a surface of each of the at least one crankpin journal and the at least one main journal upto a first pre-determined depth; and
hardening a portion of the surface proximate to each oil passage upto a second pre-determined depth.

10. The method of claim 9, wherein the peening process includes stroke peening.

11. The method of claim 9, wherein strengthening of the crankpin journal fillet further comprises strengthening a fractional arcuate portion of the crankpin journal fillet extending over an arc of 145 degrees on an axis of overlap portion of the main journal and the crankpin journal by using stroke peening process.

12. The method of claim 9, wherein strengthening of the main journal fillet further comprises strengthening a fractional arcuate portion of the main journal fillet extending over an arc of 120 degrees on an axis of overlap portion of the main journal and the crankpin journal by using stroke peening process.

13. The method of claim 9, wherein the second pre-determined depth is greater than the first pre-determined depth.

14. A method for strengthening a crankshaft having at least one crankpin journal, at least one main journal joined by a crank web, a crankpin journal fillet joining the crankpin journal and the crank web, a main journal fillet joining the main journal and the crank web, and at least one oil passage extending through the crankpin journal and the main journal, the method comprising:
hardening the crankpin journal fillet and the main journal fillet;
strengthening the crankpin journal fillet by a peening process; and
strengthening the main journal fillet by the peening process.

15. The method of claim 14 further comprising:
hardening a surface of each of the crankpin journal and the main journal upto a first pre-determined depth; and
hardening a portion of the surface proximate to each oil passage upto a second pre-determined depth greater than the first pre-determined depth.

16. The method of claim 14, wherein strengthening of the crankpin journal fillet further comprises strengthening a fractional arcuate portion of the crankpin journal fillet extending over an arc of 145 degrees on an axis of overlap portion of the main journal and the crankpin journal by stroke peening.

17. The method of claim 14, wherein strengthening of the main journal fillet further comprises strengthening a fractional arcuate portion of the main journal fillet extending over an arc of 120 degrees on an axis of overlap portion of the main journal and the crankpin journal by stroke peening.

18. A method for strengthening a crankshaft having at least one crankpin journal, at least one main journal joined to the at least one crankpin journal by a crank web, a crankpin journal fillet joining the crankpin journal and the crank web, a main journal fillet joining the main journal and the crank web, and at least one oil passage extending through the crankpin journal and the main journal, the method comprising:
hardening a surface of each of the at least one crankpin journal and the at least one main journal upto a first pre-determined depth; and
hardening a portion of the surface proximate to each oil passage upto a second pre-determined depth.

19. The method of claim 18 further comprising:
hardening the crankpin journal fillet and the main journal fillet;
strengthening the crankpin journal fillet by stroke peening; and
strengthening the main journal fillet by stroke peening.

20. The method of claim 18, wherein the second pre-determined depth is greater than the first pre-determined depth.
